(19) United States
(12) Patent Application Publication
(10) Pub. No.: US 2021/0358459 A1
(43) Pub. Date: Nov. 18, 2021

(54) Piano playing machine

(71) Applicant: Kevin Jackson, Suffield, CT (US)

(72) Inventor: Kevin Jackson, Suffield, CT (US)

(21) Appl. No.: 17/300,275

(22) Filed: May 11, 2021

Related U.S. Application Data
(60) Provisional application No. 63/204,447, filed on Oct. 5, 2020.

(51) Int. Cl. G10F 3/00; G10G 3/04

(52) U.S. Cl. CPC G10F 3/00; G10G 3/04

(57) ABSTRACT

A machine that attaches to any piano and pushes its keys and foot pedals in the order of any song. The machine can download songs from a software program and record songs played manually on a piano to replay them.

### FIELD

The present application relates to a machine that hooks to a piano and plays music on it.

### BACKGROUND

Many people buy pianos but they cannot skillfully play the music on it themselves. However, they will still purchase one to either embellish their home or so their children can play or learn to play. They may spend large sums of money on it but never get to enjoy a skillfully played song whenever they please. An electric keyboard can play preloaded songs or a piano song can be played on a radio but neither can emulate the natural sounds made by an actual piano.

### SUMMARY

A machine that fits over top of the keys on a piano and pushes keys down in the order of any song and gives a person the opportunity, to hear their favorite piano songs whenever they desire to hear them. During any social affair they can also just set the machine to play and would not have to hire someone to play it for them.

In one embodiment the machine has a small plastic pole shaped key presser for each key on the piano. The key pressers are to be placed over the keyboard on any piano and press down in the order that notes are played to a song.

In another embodiment, there is a touch screen on the machine that would present multiple options for playing songs and various settings to control it.

Further objects, features, advantages and properties of the device according to the present application will become apparent from the detailed description.

### BRIEF DESCRIPTION

In the following detailed portion of the present description, the teachings of the present application will be explained in more detail with references to the example embodiments shown in the drawings, in which:

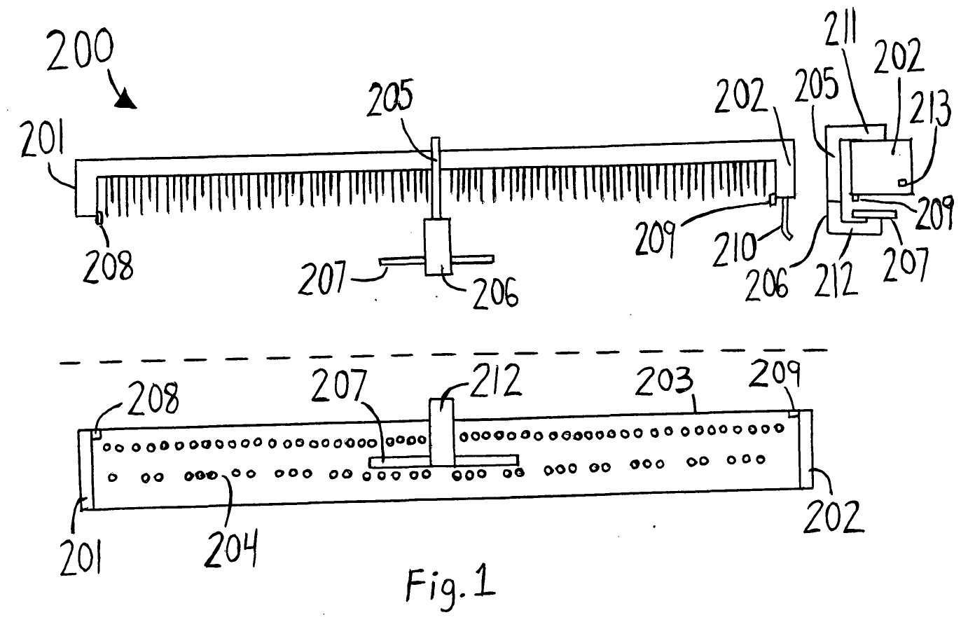

FIG. 1 is an isometric view of the piano playing machine according to a first embodiment.

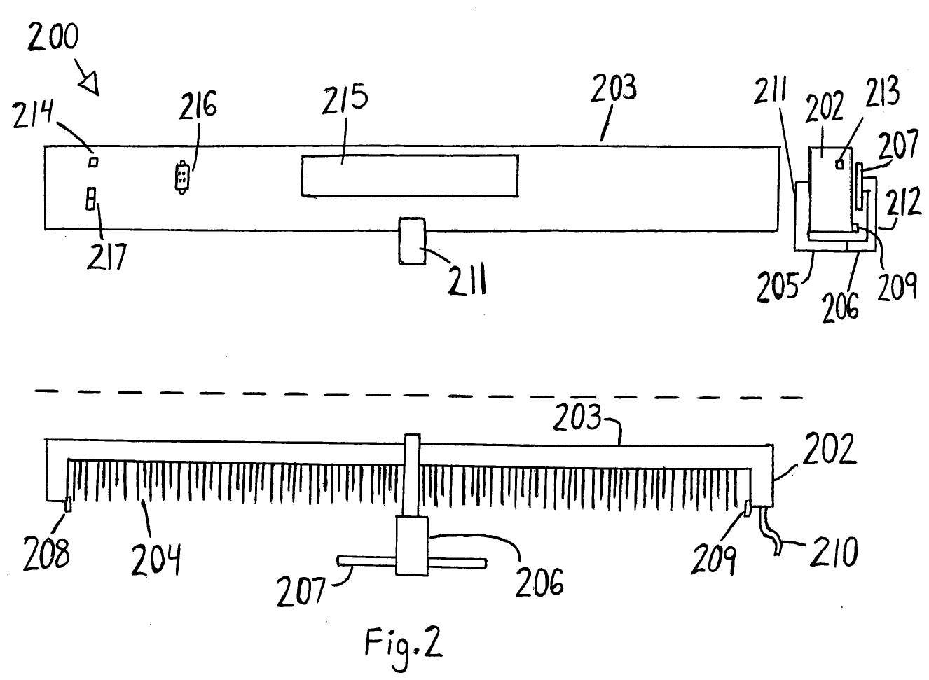

FIG. 2 is an overhead (birds eye) view of the piano playing machine according to a second embodiment.

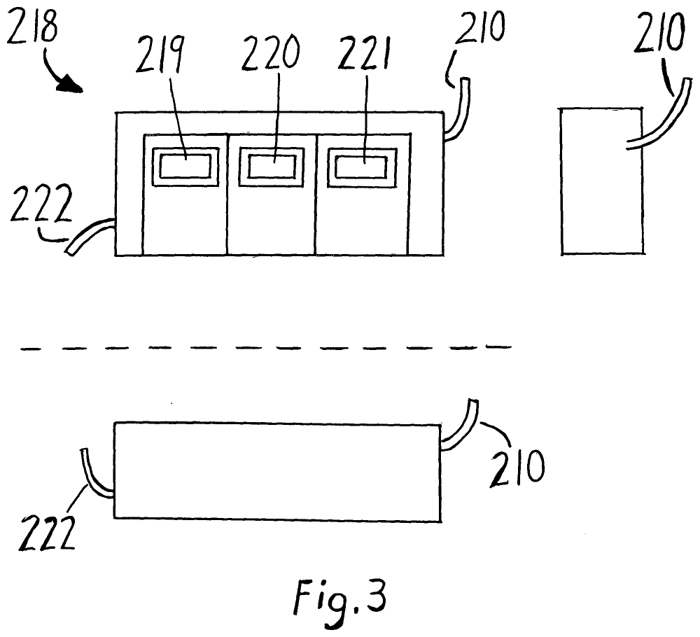

FIG. 3 is an isometrical view of the second functional part of the piano playing machine according to a third embodiment.

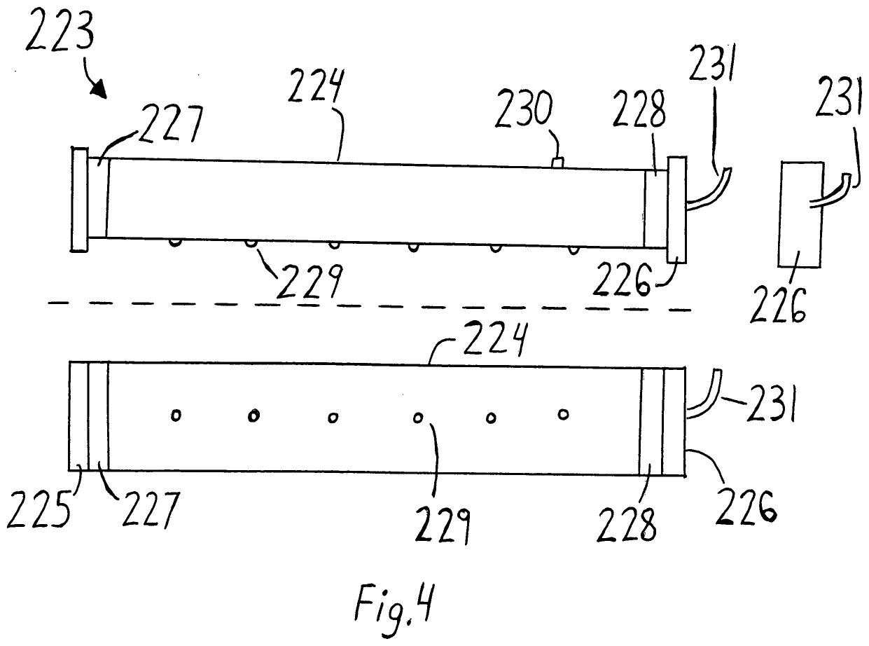

FIG. 4 is an isometrical view of the third functional part of the piano playing machine according to a fourth embodiment.

### DETAILED DESCRIPTION

In the following detailed description, the piano playing machine according to the teachings of the application in the form of a piano playing machine will be described by the embodiments. It should be noted that although the machine is displayed to fit eighty eight key piano, it can be made to fit any piano with less or more keys. It can also be made to adjust to any size key piano.

A first embodiment of the piano playing machine 200, is illustrated in FIG. 1. The Machine 200 comprises a long rectangular frame 203 that fits over the keyboard of any eighty eight key piano. The main frame 203 is made to perfectly cover over the keyboard of the piano and rest on the left and the right side of a piano's keys which has two flat surfaces leveled about half an inch above the keys. The main frame 203 has a left side 201 and a right side 202. The left side 201 is a solid hard plastic which extends downward. It is to be placed on the left side of a piano's keyboard and the right side 202 of the frame is the same function except it is placed on the right side of a piano's keyboard. Under the main frame 203, there are eighty eight small plastic stick shaped piano key pressers 204. Each one of the eighty eight key pressers 204 are the circumference of a pencil and are perfectly aligned to fit over the top of one of the keys on the piano. Each key presser 204 is firm hard plastic with a slanted tip that slants the same degree that the piano keys are slanted when pushed down.

At the bottom of the main frame 203 there is a clamp 207 that goes under the main frame 203 to hold it in place on a piano. The clamp 207 is described by five parts. The first part of the clamp 207 is a straight bar 211 which is attached to the main frame 203. The bar 211 makes a ninety degrees downward turn with bar 205 which is connected to bar 211. Bar 205 is inserted into bar 206 which is slightly wider so bar 205 fits inside of it. Connected to the bottom bar 206, there is another inward ninety degrees turn on bar 212 which turns directly under the main frame 203. On top of bar 212 there is a wide flat rectangular clamp 207. The bottom clamp 207 pushes against the bottom roof of under a piano's keys. Inside of bar 205 and bar 206 it is hollow and there is an elastic spring inside that causes the bottom clamp 207 to be able to be pulled down and maintain a sturdy upward elastic force to hold the main frame 203 over the top of a piano's keys.

To hold the main frame 203 more securely on a piano there are also a tiny flat plastic insert 208 on the left and a tiny flat plastic insert 209 on the right side of the frame which are both made to stick inside the crack underneath a piano's keys and its frame to prevent the main frame 203 from sliding off the piano.

On the right side of the main frame 203 there is a USB outlet to plug the machine into a computer. The machine 200 has a software program that enables a user to program songs into the database for the machine 200 to play. The software will read the programmed music by its notes and transfer it to the machine 200.

At the bottom of the right side frame 202 there is a cord 210 that connects the electrical components inside the main frame 203 to the electrical components inside of the second functional part of the machine 200 which controls a piano's foot pedals, which is later describe in FIG. 3.

A second embodiment of the machine 200 is illustrated in FIG. 2. The top of the main frame 203 is a flat surface comprising several different features. The power on and off button 214 is on the main frame 203. The volume control 217 is also there which controls the force given to the key pressers 204 to play the song with, and the harder they press down, the louder it will sound. There is a large touch screen 215 on the main frame 203 that allows several options such as, but not limited to, displaying the song selection, stop, pause, play, repeat and setting a playlist. There is a remote control 216 that clips onto the top of the main frame 203 to allow a user to operate its functions from a distance.

A third embodiment of the second part of the machine 200 is a piano pedal controller 218 shown in FIG. 3. The pedal controller 218 is a box shaped device that slides onto a piano's foot pedals which are three in total.

There are three holes 219, 220, and 221 that are lined in a row which the piano's foot pedals fit into. Inside of the three holes 219, 220, and 221, there is a rubber material which allows any size foot pedal to squeeze into tightly, and each hole pulls down individually to pull the pedals as the song requires. There is a cord 210 which connects to the main frame 203 to receive its instructions, and there is the power cord 222 that provides electricity to the machine 200.

A fourth embodiment of the third functional part of the machine 200 is an sensor device 223 shown in FIG. 4. The sensor device 223 fits over the keys of a piano but only the back section of the keys and it leaves most of the keys uncovered so the piano can still be played while it is on the piano. The sensor device 223 takes a recording of the order the keys are pushed down for a song to transfer the pattern of the song to the machine's database 200 so it can play any song that a person plays themselves.

The sensor device has a long frame 224 which is the length of the piano's keys. The sensor device's left end 225 is made of rubber and its right end 226 is made of rubber so it sits firmly on the piano. There is a bar 227 on the left side of the sensor device 223 and a bar 228 on the right side of the sensor device 223 which pulls in and out so it can adjust to the correct size of the piano's width.

There are six sensors 229 located under the sensor device's frame 224. The sensors 229 are shown with six but are not limited to six and they examine and record the sequence that the keys are pressed while a song is being played and they examine and record the timing that the keys are being pressed. There is a button 230 on the sensor's frame 224 which is pressed when a person is ready to begin a song and informs the sensors 229 to begin examining and recording. There is a cord 231 that transfers the data examined and recorded to the machine's database 200.

Although the teachings of the present application are described in detail for the purpose of illustration, it is to be understood that such detail is solely for that purpose and variations can be made by those skilled in the art without departing from the scope of the teaching.

The teachings of the present application are presented to be used in connection with an eighty eight key piano but it is to be understood that it can be made to fit a larger or smaller piano. It should also be noted that although the present application displays a particular clamp to attach it to a piano the way it is attached to the piano may be altered in any way to fit any particular piano. It should be understood that the machine's software program can be used in connection with an electric keyboard to record music played manually to be transferred to the machine's database.

Features described in the proceeding description may be used in combinations other than the combinations described explicitly herein.

Whilst endeavoring in the foregoing specification to draw attention to these features of the invention believed to be of particular importance, it should be understood that the Applicant claims protection in respect to any patentable feature or combination of features herein before referred to and/or shown in the drawings whether or not it be particular emphasis placed thereon.

The term “comprising” as used in the details and claims does not exclude other elements or steps. The term “a” or “an” used in the details or claims does not exclude a plurality. A unit or other means may fulfill the functions of several units or means recited in the claims.

1. A machine that attaches to a piano and can control the piano's keys.

2. A machine according to claim 1 that comprises a long rectangular frame the length of all of a piano's keys together in a row.

3. A machine according to claim 1 that comprises a clamp that extends under its frame with an upward elastic force.

4. A machine according to claim 1 that comprises an individual stick shaped key presser for each key on a piano.

5. A machine according to claim 4 that comprises individual key pressers that each press down and up on each key of a piano.

6. A machine according to claim 4 that pushes the keys on a piano in the particular order of any piano song.

7. A machine according to claim 1 that comprises a database that can receive notes of any piano song from a software program.

8. A machine according to claim 7 that comprises a USB outlet that connects the database to a computer.

9. A machine according to claim 7 that comprises an electrical component that can recognize the notes of a piano song.

10. A machine that comprises an attachment machine that controls a piano's foot pedals.

11. A machine according to claim 10 that has three individual holes that pull downward individually in any particular order of the notes to a song that requires piano foot pedals to be pressed.

12. A machine according to claim 10 that can recognize the notes of any piano song.

13. A machine according to claim 10 that can receive notes to any piano song from the machine's database.

14. A machine that comprises an attachable device that records any particular order that keys on a piano are pressed.

15. A device according to claim 14 that comprises a rectangular frame that is the width of all of a piano's keys together in a row.

16. A device according to claim 14 that comprises a frame that covers only half of a piano's keys.

17. A device according to claim 14 that recognizes the note that each key on a piano represents.

18. A device according to claim 14 that comprises a series of sensors that recognizes all of the keys on a piano.

19. A device according to claim 18 that comprises sensors that record any particular order that keys are pressed on a piano.

20. An attachable device according to claim 14 that sends a piano song's notes to the machine's main database.
